(19) United States
(12) Patent Application Publication
(10) Pub. No.: US 2008/0115993 A1
(43) Pub. Date: May 22, 2008

(54) Method For Multi-Operating Mode Control Of An Automated Transmission For A Motor Vehicle, In Particular For Idle Speed Runing With Inactivated Brake And Corresponding Device

(75) Inventors: Frederic Roudeau, Vitry Sur Seine (FR); Jean Bretheau, Antony (FR); Vincent Vermuse, St Germain Les Arpajons (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.S., Boulogne Billancourt (FR)

(21) Appl. No.: 11/575,041

(22) PCT Filed: Sep. 6, 2005
(86) PCT No.: PCT/FR05/50711

§ 371 Date: Oct. 18, 2007

(30) Foreign Application Priority Data
Sep. 10, 2004 (FR) 0409652

(51) Int. Cl. B60K 31/04; F16H 61/20; B60W 30/18

(52) U.S. Cl. 180/179; 701/51

(57) ABSTRACT

A method for controlling automated transmission for a power train of a motor vehicle, including producing a first setpoint signal of a variable applicable to the vehicle wheels and including dynamic and static components formed taking into consideration input representative data of the motor vehicle characteristics, a drive's wish, and an environment of the vehicle, in selecting, according to the input data, one mode from at least two different operating modes able to transmit the setpoint signal. One operating mode corresponds to a torque creeping mode for transmitting the setpoint signal when the motor vehicle runs with a speed lower than a predetermined threshold and the brake pedal thereof is inactivated.

The present invention relates to the control of the operating mode of a power train equipped with a motor vehicle automated transmission.

This control device advantageously applies to automated transmissions in particular to impulse control boxes termed “BCI”, automatic control boxes termed “BVA” and robotized, gear boxes termed “BVR”, but also continuous-ratio transmissions, such as CVT (“continuous variable transmission”), IVT (“infinitely variable Transmission”) and hybrid transmissions.

A transmission conventionally comprises a control block receiving one or more input parameters interpreting the desire of the driver. Then, as a function of the value of these parameters, this control block delivers a control setpoint with a view to application to the wheels of the motor vehicle.

An upgrade of such a control block has already been described in document FR-A-2827339, in the name of the Applicant. This document details a device for controlling the operating point of a power train. The control carried out by this device is a torque control to be applied to the wheels of the motor vehicle. As defined in document FR-A-2827339, the value of the torque to be applied to the wheels of the motor vehicle, is calculated directly at the wheels of the motor vehicle.

The device of document FR-A-2827339 possesses a module for interpreting the desire of the driver called an “IVC module”. The IVC module generates a torque setpoint to be applied to the wheels, destined for a block for optimizing the operating point OFF. The latter transmits said torque with a view to a torque control to be applied to the wheels of the motor vehicle. The OFF block simultaneously generates an engine revs setpoint on the basis of said torque to be applied to the wheels of the motor vehicle. This torque setpoint is determined as a function of the desire of the driver, of the characteristics of the motor vehicle and of its environment.

However, in the case of an automated transmission, there exist specific modes such as the “Creeping” mode and the “Neutral” mode, linked with the automated transmission and that are not found in the case of a mechanical transmission. The “Creeping” mode corresponds to an idling advance of the motor vehicle, when the gear lever is in the position termed “Drive” or “D” . The “Neutral” mode corresponds to a freewheeling advance of the vehicle when the control lever is in the position termed “Neutral” or “N”.

The module for interpreting the desire of the driver of document. FR-A-2827339 does not take these particular modes of operation into account, in particular in the case where the motor vehicle crawls forward while having load or slope constraints for example. In this configuration, it is particularly important to bring the motor vehicle progressively to a constant speed, and to maintain, this constant speed independently of the load and of the slope of the road.

In the case where the brake of the motor vehicle is activated, a so-called “Torque Creeping” mode is in effect. The objective is then to ensure a setpoint sufficient to prevent the motor vehicle from moving backward. It is moreover envisaged for controlling the motor vehicle, as a function of the depression of the brake pedal by the driver and of the speed of the motor vehicle.

In the case where the brake of the motor vehicle is not activated, and the aim is to maintain a constant and low speed, a so-called “Speed Creeping” mode is in effect, The objective is then to follow the speed setpoint independently of the slope of the road and/or of the load. This mode is especially suited to the following of a line of traffic for example.

A device which prevents the motor vehicle from going backward as it crawls forward on an inclined plane is known for this operating mode, through document U.S. Pat. No. 5,543,525 (ZF). Therefore, the device envisages control but only at the transmission level.

A device for controlling a power train of a motor vehicle so as to ensure a “Creeping” mode is likewise known through document U.S. Pat. No. 4,951,146 in the name of MITSUBISHI. More precisely, this control is performed by varying the degree of opening of the lone throttle valve of the engine.

A method making it possible to ensure a “Speed Creeping” function in the case of a motor vehicle furnished with a continuous-ratio transmission is known through the document US 2002/115529 in the name of NISSAN. This method consists in continuously varying the gear ratio setpoint of the transmission of the motor vehicle.

A method and its associated device make it possible to ensure a “Speed Creeping” function is known through the document US 2003/01171186 in the name of HITACHI. This method consists in generating an engine torque setpoint intended for the engine of the motor vehicle and making it possible to control the engine as well as a torque transfer member such as a converter or a clutch.

An aim of the invention is to alleviate the defects of the various solutions described in the aforesaid patent applications so as to meet the desire of the driver as far as possible, in particular when, the motor vehicle is in the “Speed Creeping” mode, that is to say when the motor vehicle advances slowly without the brake being activated.

Accordingly, the invention proposes a method of controlling an automated transmission of a power train for a motor vehicle, comprising a step of formulating a setpoint signal of a variable applied to the wheels of the motor vehicle, said setpoint comprising a dynamic component and a static component formulated by taking account of input data representative of the characteristics of the motor vehicle, of the desire of the driver and of the environment of the motor vehicle. As a function of said input data, a mode is selected from among at least two different operating modes, capable of delivering said setpoint signal, one of the two operating modes corresponding to a mode termed “Speed Creeping” able to deliver said setpoint signal when the motor vehicle advances at a speed less than a predetermined threshold and when the brake pedal of the motor vehicle is inactivated.

The mode termed “Speed Creeping” makes it possible to offer a mode of driving appropriate to the movement of the motor vehicle and while idling, when the driver does not activate the brake pedal. This mode of driving will make it possible in particular to bring the motor vehicle progressively to a constant speed. This mode, especially suited to the following of a line of traffic, will also make it possible to maintain the constant speed independently of the load of the motor vehicle and of the slope of the road.

According to a mode of implementation, the “Speed Creeping” mode and/or the value of the setpoint delivered when said “Speed Creeping” mode is selected, are determined as a function of a signal representative of a measured speed and/or of a signal representative of a target speed that the motor vehicle roust reach.

According to a mode of implementation, the “Speed Creeping” mode and/or the value of the setpoint delivered when said “Speed Creeping” mode is selected, are determined as a function of a signal representative of the dynamic component of the setpoint undergoing application.

According to a mode of implementation, the “Speed Creeping” mode and/or the value of the setpoint delivered when said “Speed Creeping” mode is selected, are determined as a function of a signal representative of the resistive torques applied to the wheel and that the motor vehicle must overcome so as to foe able to move off.

The invention also proposes a device for controlling an automated transmission of a power train for a motor vehicle, able to deliver setpoint signals of a variable applied to the wheels of the motor vehicle, said setpoint comprising a dynamic component and a static component formulated by taking account of input data, delivered by an input block and comprising a list of parameters defining the characteristics of the motor vehicle, the desire of the driver and the environment of the motor vehicle. The control device comprises:
a control block comprising at least two modules according to two distinct and predetermined operating modes, one of the modules corresponding to a mode termed “Speed Creeping”, selected when the motor vehicle advances at a speed less than a predetermined threshold and when the brake pedal of the motor vehicle is inactivated,
a selection module receiving the signals originating from said input block and able to deliver a. selection signal for one of said modules as a function of the input data.

According to an embodiment, the module intended for the operating mode termed “Speed Creeping” comprises:
a calculation block able to formulate a speed setpoint on the basis of a measured speed of the motor vehicle, of a target speed setpoint that the motor vehicle must reach and of an initialization signal,
correction means able to perform a proportional and/or integral and/or derivative correction on the speed setpoint formulated by the first block, and to each deliver a corrected torque setpoint,
first means for initializing and adapting the speed setpoint to be corrected by the correction means performing the integral correction, as a function of the initialization signal and of the value of a dynamic torque setpoint undergoing application,
a filter able to saturate and filter a raw dynamic torque setpoint in “Speed Creeping” mode formulated on the basis of the torque setpoints corrected by the correction means,
means for performing operations on the variables delivered by the blocks included in the module intended for the operating mode termed “Speed Creeping”:,
means for delivering the static torque setpoint in “Speed Creeping” mode on the basis of the value of the dynamic torque setpoint in “Speed Creeping” mode, a minimum torque quantity to be applied, to the wheel, and a signal representative of the resistive torques applied to the wheel and that the motor vehicle must overcome so as to be able to move off.

According to an embodiment, the calculation block comprises,
second initialization means able to initialize an intermediate variable, with the value of the measured speed of the motor vehicle or the value of the speed setpoint formulated by the calculation block at the previous time step,
saturation means, able to reduce the deviation between the target speed, desired by the driver and the intermediate variable,
means for performing operations on the variables delivered by the block included in the calculation block.

Other advantages and characteristics of the invention will appear on examination, of the detailed description of a wholly nonlimiting mode of implementation, and of the appended drawings, in which:

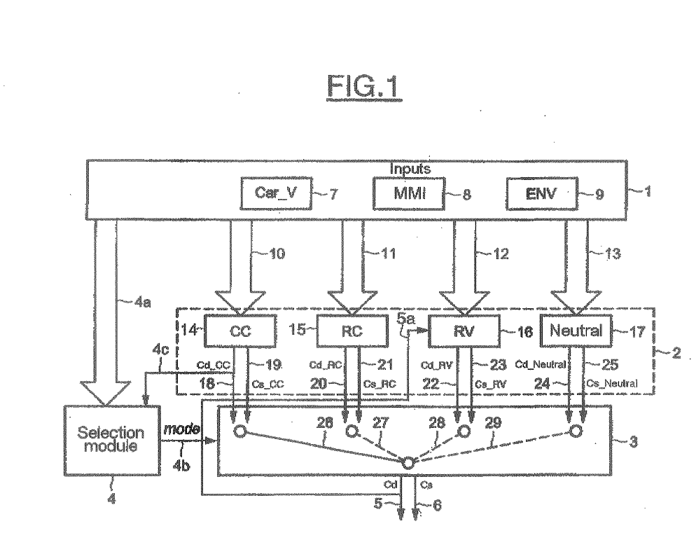

FIG. 1 diagrammatically illustrates an exemplary embodiment of a device according to the invention,

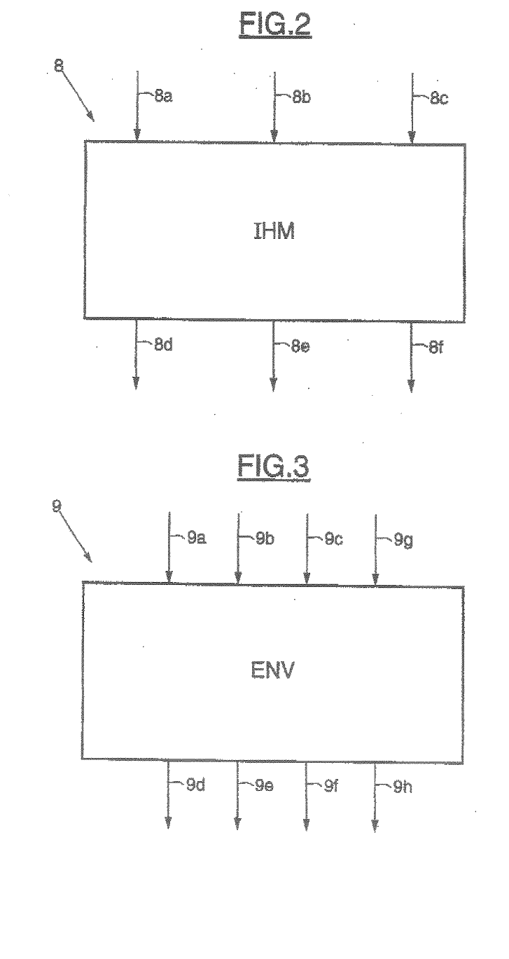

FIG. 2 diagrammatically illustrates and in greater detail a part of FIG. 1,

FIG. 3 diagrammatically illustrates and in greater detail a part of FIG. 1,

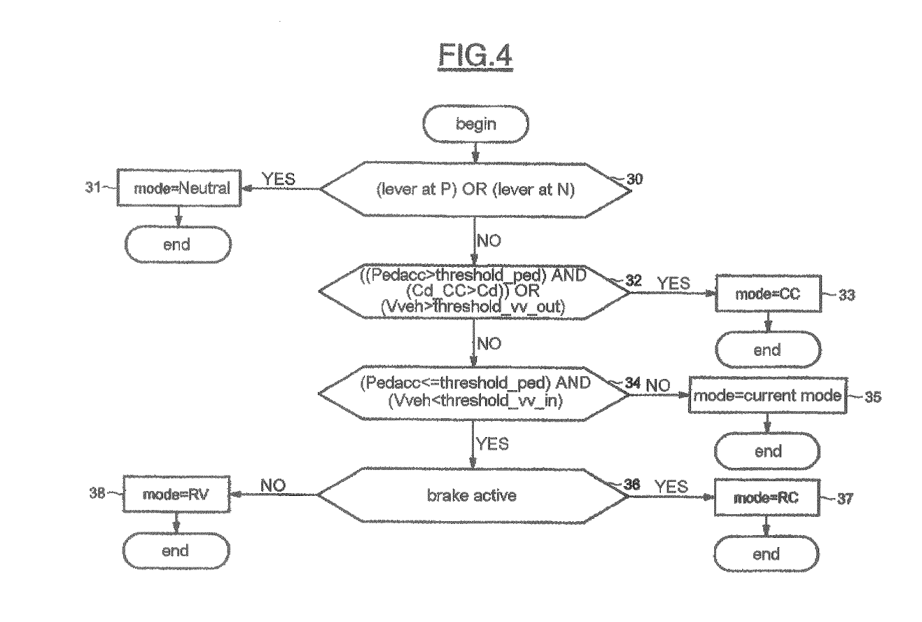

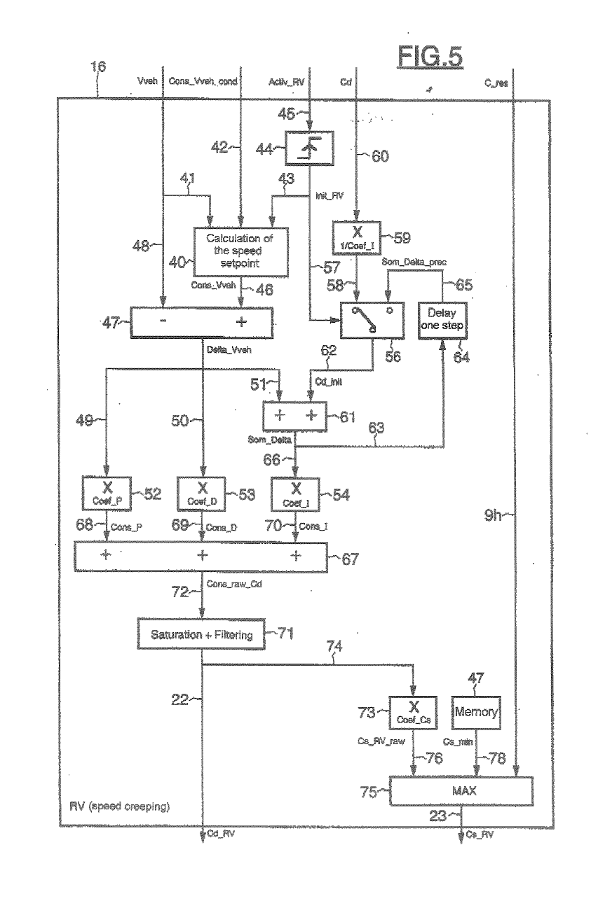

FIG. 4 illustrates an example of the various operation steps during the selection of an operating mode,

FIG. 5 diagrammatically illustrates in greater detail a module of the device of FIG. 1,

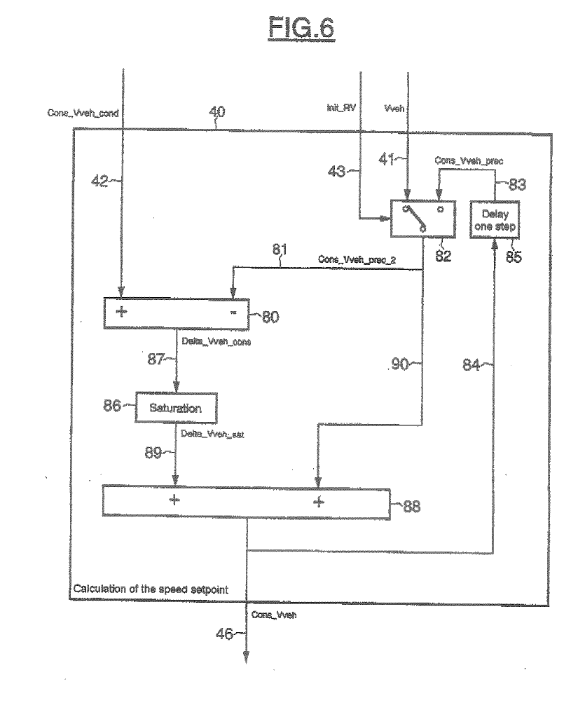

FIG. 6 diagrammatically illustrates in greater detail a module of the device of FIG. 5,

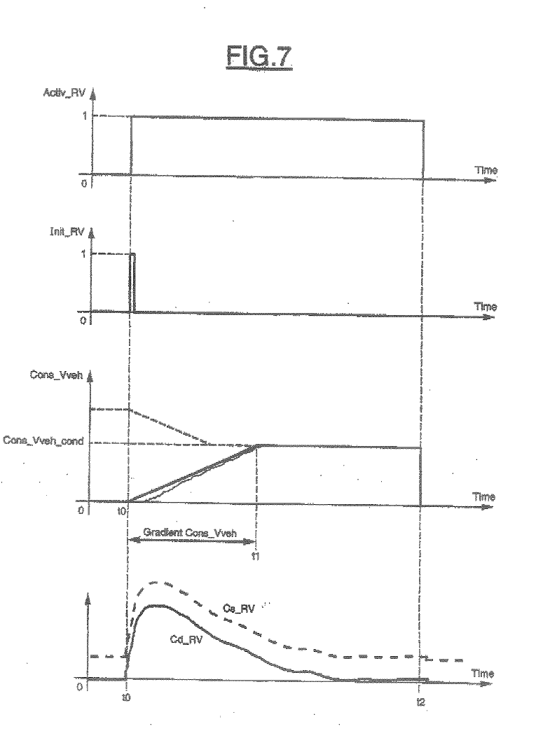

FIG. 7 represents curves of the evolution of the variables generated by modules represented in FIGS. 1 to 6.

Represented diagrammatically in FIG. 1 is an example of an embodiment of the device according to the invention. This device can be included in a control box for a motor vehicle automated transmission, not represented in the figure.

Such as is illustrated in FIG. 1, the control device comprises an input block 1 transmitting input data to a control block 2. The latter delivers various setpoints according to each operating mode to a selector 3. A selection module 4 dispatches, as a function of the input data delivered by the input block 1 via the connection 4a, a control signal “mode” to the selector 3 via the connection 4b. The selector 3 selects, from among the various setpoints delivered by the control block 2, the setpoint suited to the control signal “mode” and delivers the setpoint signal. This signal comprises two components, one static Cs which travels via the connection 6 and the other dynamic Cd which travels via the connection 5.

The static component Cs in the example illustrated, is the maximum value of the torque applicable to the wheels of the motor vehicle that the driver could request and that the power train must immediately make available to the wheels of the motor vehicle.

In other variants, the magnitudes formulated by the device can be a force or a power.

The input block 1 comprises three modules 7, 8 and 9 which will formulate a data signal on the basis of the signals arising from sensors, not represented, integrated within the motor vehicle.

The module 7 is capable of formulating the data relating to the characteristics of the motor vehicle. The latter are programmed and stored by the constructor so as to characterize the behaviour of the motor vehicle delivered to a customer.

The module 8 is capable of formulating data relating to the desire of the driver (man/machine interface, MMI). These data interpret the wishes that the driver transmits. By referring to FIG. 2 which describes more precisely the data formulated by the module 8, it is noted, that it delivers signals such as a signal traveling via the connection 8d corresponding to the control lever for the transmission of the motor vehicle traveling via the connection 8a, a signal traveling via the connection 8e corresponding to the brake of the motor vehicle 8b, or else a signal traveling via the connection 8f representative of the depression of the pedal for accelerating the motor vehicle 8c.

The module 9 is capable of formulating signals relating to the environment of the motor vehicle. These make it possible to take account of the state of the motor vehicle and of its situation in the environment. By referring to FIG. 3 which describes more precisely the data formulated by the module 9, it is noted that it delivers signals such as a signal traveling via the connection 3d corresponding to the speed of the motor vehicle 9a, a signal traveling via the connection 9e and representative of the state of the carriageway 9b, a signal traveling via the connection 9f and representative of the meteorological conditions 9c, a signal traveling via the connection 9h and representative of the resistive torques 9g applied to the wheel that the vehicle must overcome so as to be able to move off.

The value of the parameters and the state of the variables of the input data transmitted! by these three modules are stored in a memory, not represented, common to each element of the device.

The control block 2 possesses four distinct modules each corresponding to a particular operating mode of the motor vehicle. These control blocks receive all the input data of the input block 1 via four distinct connections respectively the connection 10 for the first module 14 of the control block 2, the connection 11 for the second module 15, the connection 12 for the third module 16 and the connection 13 for the fourth module 17.

The four modules of the control block 2 are capable of delivering a setpoint signal according to four different modes, namely the “Continuous Control” mode, the “Speed Creeping” mode, the “Torque Creeping” mode and the “Neutral” mode.

As a function of the values of the input parameters, a first configuration represented in FIG. 1 holds. The mode chosen by the selection module 4 is the “Continuous Control” mode termed “CC” mode corresponding to the operating mode module 14. This mode is used when the speed of the motor vehicle is greater than a certain predetermined threshold. Moreover, it is necessary that the, module of the “Continuous Control” operating mode continually generates its setpoint at the wheels of the motor vehicle even when it is not chosen by the selection module 4, since the value of the dynamic setpoint in “Continuous Control” mode, serves as reference value for the selection module 4 to which it is transmitted via the connection 4c. By way of example it is possible to refer to the document FR-A-282 733 9, this “Continuous Control” mode pertains to the module for interpreting the desire of the driver, IVC. The “CC” mode is able to generate a dynamic setpoint “Cd_CC” and a static setpoint “Cs_CC” respectively transmitted by a first input of the selector 3 via the connections 18 and 13, In this configuration where the “CC” mode is chosen, the selector 3 then selects the first input by establishing a connection 26 between its first input and its output. The selector 3 can then deliver the static and dynamic setpoints Cs and Cd corresponding respectively to the setpoints “Cs_CC” and “Cd_CC”.

As a function of the values of the input parameters, it is possible to be in a second configuration. The mode chosen by the selection module 4 is the “Torque Creeping” mode termed “RC” mode corresponding to the operating mode module 15 and which is an additional mode with respect to document FR-A-2827339. The “RC” mode is activated when the motor vehicle advances while idling with the brake activated. It makes it possible to generate a dynamic setpoint “Cd_RC” and a static setpoint “Cs_RC” respectively transmitted via the connections 20 and 21 to a second input of the selector 3. This formulation method will be described, in greater detail hereafter. In the configuration where the “RC” mode is chosen, the selector 3 selects said second input by establishing a connection 27 between its second input and its output. The selector 3 can then deliver the static and dynamic setpoints Cs and Cd respectively corresponding to the setpoints “Cs_RC” and “Cd_RC”.

As a function of the values of the input parameters, it is possible to be in a third configuration. The mode chosen by the selection module 4 is the “Speed Creeping” mode termed “RV” mode corresponding to the operating mode module 16 and which is also an additional mode with respect to document FR-A-2327339. The “RV” mode is activated when the motor vehicle advances while idling with the brake inactive. It makes it possible to generate a dynamic setpoint “Cd_RV” and a static setpoint “Cs_RV” respectively transmitted via the connections 22 and 23 to a third input of the selector 3. Furthermore, the dynamic setpoint Cd undergoing application is transmitted via the connection 5a with the module 16 so as to formulate a new dynamic setpoint. In this configuration, the “RV” mode is chosen, the selector 3 selects said third input by establishing a connection 28 between its third input and its output. The selector 3 can then deliver the static and dynamic setpoints Cs and Cd corresponding respectively to the setpoints “Cs_RV” and “Cd_{—RV”.}

As a function of the values of the input parameters, it is possible to be in a fourth configuration. The mode chosen by the selection module 4 is the “Neutral” mode corresponding to the operating mode module 17 and which is also an additional mode with respect to document FR-A-2827339. The “Neutral” mode is activated when the control lever of the automated transmission is in the “Parking” position termed “P” that is to say in the latching position, or in the “Neutral” position termed “N” that is to say when the motor vehicle is freewheeling. It makes it possible to generate a dynamic setpoint “Cd_Neutral” and a static setpoint “Cs_Neutral” respectively transmitted via the connections 24 and 25 to a fourth input of the selector 3. In this configuration where the “Neutral” mode is chosen, the selector 3 selects said fourth input by establishing a connection 29 between its fourth input and its output. The selector 3 can then deliver the static and dynamic setpoints Cs and Cd corresponding respectively to the setpoints “Cs_Neutral” and “Cd_Neutral”.

The unselected operating mode modules are capable of generating a default setpoint, although according to a variant of the invention, they could also generate a setpoint only if they were selected, except the module 14 of the “Continuous Control” mode which must deliver a setpoint in all cases.

FIG. 4 illustrates the operation of the selection module 4 during the choice of the operating mode.

First of all, the selection module 4 adopts a sequential operating mode. The updating of the value of the input parameters is performed periodically. For example, it can be done every 20 ms (50 Hz).

The flowchart represented in FIG. 4, shows the various analysis and comparison tests carried out on the data formulated by the input block 1 and transmitted via the connection 4a. These tests are carried out by various comparison means according to the following process.

At each refresh, a first step 30 consists in verifying the state of the control lever. If the latter is in the position termed “Parking” or “P”, or termed “Neutral” or “N” (lever at P OR lever at N) , then the Neutral mode 31 is chosen.

If the control lever of the motor vehicle is neither in the “Parking” position nor in the “Neutral” position, the selection module passes to a step 32 and verifies the depression of the acceleration pedal Pedacc, the value of the dynamic component of the current setpoint Cd and the speed of the motor vehicle Vveh.

To validate this step 32, either the depression of the acceleration pedal, of the motor vehicle is strictly greater than a predetermined, threshold of depression of the acceleration pedal and, simultaneously, the dynamic component of the current setpoint is strictly less than the dynamic component of the setpoint sent by the “Continuous Control” mode, or the speed of the motor vehicle is strictly greater than a first predetermined speed threshold ((Pedacc>threshold_ped AND Cd_CC>Cd) OR Vveh>threshold_vv_out). The chosen mode is then the “Continuous Control” mode 33. Otherwise, we pass to the following test step 34.

During step 34, the depression of the acceleration pedal of the motor vehicle Pedacc and the speed of the motor vehicle Vveh are tested. If the depression of the acceleration pedal of the motor vehicle is less than or equal to the predetermined threshold of depression of the acceleration pedal and, simultaneously, if the speed of the motor vehicle is strictly less than a second predetermined speed threshold (Pedacc<=threshold_ped AND Vveh<threshold_vv_in) then we pass to a following test step 36.

If these conditions do not hold then the current mode 35 is retained.

During step 36, the activity of the brake of the motor vehicle brake is considered, if the latter is active (brake active) , then the “Torque Creeping” mode 37 is chosen, otherwise the “Speed Creeping” mode 38 is chosen.

The two predetermined and distinct speed thresholds threshold_vv_in and threshold_vv_out make it possible to avoid the phenomena of hysteresis to which the device could be sensitive, that is to say the phenomena of oscillations between two operating modes on account of the oscillation of the value of a parameter about a predetermined threshold.

Conventionally, a hysteresis curve possesses two triggering thresholds allowing a given output variable to change value. Specifically, if there were a single decision threshold, the smallest variation of the value of the input variable, for example electrical noise, would make the output variable oscillate between the two values.

Also, the first threshold of the hysteresis curve allows the output variable to change value if the input variable decreases, and the second threshold if the input variable increases, the value of the second threshold being higher than that of the first threshold.

FIG. 5 describes more particularly the operating mode module 16 corresponding to the “Speed Creeping” mode presented in FIG. 1. This mode corresponds to an advance while idling of the motor vehicle without the brake pedal being activated, that is to say when the speed of the motor vehicle is less than the second predetermined speed threshold and when the accelerator pedal setpoint “Pedacc” is less than the threshold “threshold_ped”, as indicated in FIG. 4.

The module 16 receives various input parameters such as the measured speed of the motor vehicle denoted “Vveh”, the setpoint target speed of the motor vehicle, desired by the driver, denoted “Cons_Vveh_cond.” The module 16 also receives as input a signal denoted “Activ_RV” delivered by a piece of software (not represented) instructing the device, “Activ_RV” taking the value “1” during the activation of the “RV” mode, such as represented on the curve “Activ_RV” of FIG. 6.

FIG. 5 is referred to again. The module 16 receives moreover the value of the previous dynamic setpoint denoted Cd, and a signal denoted C_Res, representative of the resistive torques applied to the wheel and that the motor vehicle must overcome in order to be able to move off.

The module 16 comprises a calculation block 40 (calculation of the speed setpoint) able to determine the instantaneous speed setpoint “Cons_Vveh” of the motor vehicle. The calculation block 40, which will be described in greater detail hereinafter, determines the instantaneous speed setpoint of the vehicle “Cons_Vveh” on the basis of the speed of the motor vehicle “Vveh” delivered via a connection 41, of the final speed setpoint of the motor vehicle chosen by the driver “Cons_Vveh_cond” delivered via a connection 42, and of a signal “Init_RV”, delivered via a connection 43. The signal “Init_RV” is an initialization signal formulated by a module 44 as a function of the variable “Activ_RV” delivered to the module 44 via a connection 45, The module 44 generates a step over a timespan during the activation of the “RV” operating mode, that is to say when the variable “Activ_RV” switches from the value “0” to the value “1”. On completion of the timespan, the variable “Init_RV” reverts to the value “0”. FIG. 7 represents the evolution of the variable “Init_Rv” as a function of time with respect to the values of the variable “Activ_RV” also represented in FIG. 7.

Reference is now made to FIG. 5, The calculation block 40 delivers the instantaneous speed setpoint of the motor vehicle “Cons_Vveh” via a connection 46 to a subtracter 47. The subtracter 47 receives also as input the speed of the motor vehicle “Vveh” via a connection 48, The subtractor 47 calculates the deviation “Delta_Vveh” between the instantaneous speed setpoint of the motor vehicle “Cons_Vveh” and the current speed of the motor vehicle “Vveh”.

The deviation “Delta_Vveh” is delivered respectively via the connections 49, 50, 51 to three correction blocks 52, 53 and 54 after a prior processing. Three blocks 52, 53 and 54 are able to perform a so-called PID slaving, that is to say a proportional, integral, derivative slaving. The block 52 makes it possible to perform a proportional saving by applying a coefficient Coef_P. The proportional slaving allows the system to converge more quickly to its final value. However, the speed of the engine never reaches the desired speed. This margin represents the static error. It corresponds to the difference between the actual speed and the desired speed in the steady state, that is to say once the system is stabilized. To compensate for this static error, an integral slaving is performed.

This integral slaving is performed by the block. 54. The correction performed by the block 54 serves mainly to eliminate the static error by applying a coefficient Coef_I. The principle of the integral correction consists in integrating the error from the beginning and in adding this error to the setpoint until it becomes zero. When this error is zero, the “integral” term stabilizes and it compensates perfectly for the error between the setpoint and the actual speed, in order to decrease the initial static error, and to thus avoid too significant a jump in torque, the module 16 comprises first means for initializing the integral correction block 54. The first initialization means comprise a selector 56. The selector 56 is controlled by the signal “Init_RV” delivered via a connection 57. The selector 56 receives as input, via a connection 58, a initialization value delivered by a block 59. This initialization value is equal to the last value of the dynamic torque to be applied to the wheel Cd, delivered to the block 59 via a connection 60, The block 59 multiplies this initialization value by a coefficient equal to the inverse of the coefficient “Coef_I”. Thus, when the variable “Init_RV” takes the value “1”, the block 56 delivers to an adder 61, via a connection 62, a variable “Cd_Init”.

During this initialization period, the variable “Som_Delta” is then equal to:

Som_Delta=Delta_Vveh+(Cd/Coef_I).

The adder 61 also receives as input, via a connection 51, the variable “Delta_Vveh”, arising from the block 47. The adder 61 then calculates a variable “Som_Delta”, equal to the sum between the variable “Delta_Vveh” and the variable “Cd_Init”.

The variable “Som_Delta” is delivered, via a connection 63, to a delay means 64. This delay means 64 formulates a variable “Som_Delta_prec” which is equal to the variable “Som_Delta” delayed by a timespan. The variable “Som_Delta_prec” is delivered via a connection 65 to the selector 56. Thus, when the variable “Init_RV” is equal to “0”, the variable “Cd_init” delivered by the block 56 is equal to “Som_Delta_prec”, outside of the initialization period.

Furthermore, the variable “Som_Delta”, is delivered via a connection 66 to the correction block 54, in such a way that the variable “Delta_Vveh” is delivered to the correction blocks 52 and 53.

The third correction block 53 is used to perform a so-called “derivative” slaving. To do this, the correction block 53 applies a coefficient “Coef_D” to the setpoint “Delta_Vveh”, delivered via the connection 50. This derivative correction makes it possible to decrease the overshoot and the oscillations generated by the integral correction performed by the block 54.

The three correction blocks 52, 53 and 54 deliver respectively torque setpoints to be applied to the wheel corrected respectively “Cons_P”, “Cons_D”, “Cons_I”, such that:

Cons_P=Coef_P*Delta_Vveh,

Cons_D=Coef_D*Delta_Vveh,

Cons_I=Coef_I*Som_Delta.

These torque setpoints are delivered to an adder 67 respectively via the connections 68, 63, 70. The adder 67 then formulates a raw torque setpoint “Cons_raw_Cd” . The setpoint “Cons_raw_Cd” is delivered to a saturation and filtering block 71. The setpoint “Cons_raw_Cd” is delivered to the block 71 via a connection 72. The saturation performed by the block 71 makes it possible to prevent the setpoint “Cd_RV” from taking values outside of predefined limit values. The block 71 also performs a time filtering so as to avoid abrupt variations in torque.

The block 71 delivers as output the dynamic torque setpoint to be applied to the wheel “Cd_RV”.

in FIG. 5, the module 16 also comprises means for formulating the static component of the setpoint “Cs_RV” in “RV” mode, on the basis of the setpoint “Cd_RV”.

Accordingly, it comprises a block 73 formulating a setpoint “Cs_RV_raw,” on the basis of the dynamic component of the setpoint “Cd_RV” transmitted via a connection 74 to the block 73. The block 73 formulates the static component “Cs_RV_raw” by multiplying the setpoint “Cd_RV” by a coefficient Coef_Cs, representing a desired torque reserve to be applied to the wheel.

a block 75 (max) receives as input the setpoint “Cs_RV_raw” via a connection 76, as well as a constant “Cs_min” delivered to the module 75 by a memory (Memory) 77, by way of a connection 78, The constant “Cs_min” represents a minimum torque quantity to be applied to the wheel. The block 75 also receives as input via the connection 9h, the signal “C_res” representative of the resistive torques applied to the wheel so as to allow an immediate pullaway of the motor vehicle. The block 75 formulates the static component “Cs_RV” by taking the maximum of the three signals received as input “Cs_RV_raw”, “Cs_min” and “C_res”.

Reference is now made to FIG. 6. FIG. 6 describes in greater detail the block 40 able to calculate the speed setpoint “Cons_Vveh”. The block 40 comprises a subtracter 80 which performs the difference between the setpoint “Cons_Vveh_cond” delivered via the connection 42 to the block 40 and an intermediate setpoint “Cons_Vveh_Prec_{—}2” delivered via a connection 81 to the block 80.

The intermediate setpoint “Cons_Vveh_Prec_{—}2” arises from second initialization means included in the block 40. The second initialization means comprise a selector 82 controlled by the initialization signal “Init_RV” delivered via the connection 43. The selector 82 receives as input the speed, of the motor vehicle “Vveh”, delivered via the connection 41. When the control signal “Init_RV” takes the value “1” the intermediate variable “Cons_Vveh_Prec_{—}2” then takes the value of the speed of the motor vehicle “Vveh”. Otherwise, when the value of the initialization variable “Init_RV” is equal to “0”, the block 82 then delivers a variable “Cons_Vveh_Prec” that the block 82 also receives as input via a connection 83.

The setpoint “Cons_Vveh_Prec” is delivered by a delay means 85. The delay means 85 formulates the setpoint “Cons_Vveh_Prec” on the basis of the instantaneous speed setpoint “Cons_Vveh” delivered to the delay means 85, via a connection 84.

The subtractor 80 then performs the difference between the speed setpoint formulated by the driver “Cons_Vveh_Cond” and the intermediate variable “Cons_Vveh_Prec_{—}2” equal to the speed of the motor vehicle when the control variable “Init_RV” is equal to “1”, or to the instantaneous speed setpoint “Cons_Vveh” delayed by a timespan when the initialization command “Init_RV” is equal to “0”, stated otherwise “Cons_Vveh_Prec”.

The deviation “Delta_Vveh_Cons” formulated by the subtractor 80 is delivered to a saturation block 86 via a connection 87. The block 86 saturates the deviation “Delta_Vveh_Cons” in such a way that the instantaneous speed setpoint “Cons_Vveh” is limited to calibratable minimum and maximum values. This mechanism makes it possible to bring the setpoint “Cons_Vveh” progressively to the setpoint requested by the driver “Cons_Vveh_cond” . The block 86 then delivers a saturated setpoint “Delta_Vveh_sat”.

An adder 88 receives as input the setpoint “Delta_Vveh_sat” via a connection 89. The adder 88 adds the setpoint “Delta_Vveh_sat” to the intermediate value “Cons_Vveh_Prec_{—}2” delivered to the block 88 via a connection 90. The adder 88 then delivers, via the connection 46, the updated instantaneous speed setpoint “Cons_Vveh”.

Reference is now made to FIG. 7.

FIG. 7 again takes up the evolution of the setpoints “Cd_RV” and “Cs_RV” of the “RV” operating mode.

The instant t0 corresponds to the switching of the “Activ_RV” variable to the value “1” represented in the first curve. At the instant t0, the variable “Init_RV”, represented on the second curve, takes the value “1” for a temporal timespan.

On the third curve, the evolution of the setpoint of the instantaneous speed “Cons_Vveh” is observed. During the temporal timespan where the variable “Init_RV” takes the value “1”, the instantaneous speed setpoint is initialized to the value of the speed of the motor vehicle. The case where the initial speed of the motor vehicle is zero has been plotted as a solid line. The case where the instantaneous speed of the motor vehicle is greater than the speed setpoint formulated by the driver is plotted with dashes.

Between the instants t0 and t1, the gradient of the instantaneous speed setpoint, that is to say the difference between the speed setpoint formulated by the driver and the instantaneous speed setpoint, decreases until it finally meets the speed setpoint formulated by the driver, “Cons_Vveh_cond” . The curve of the speed of the motor vehicle “Vveh” in the case where the initial speed of the motor vehicle is zero, represented, by a fine line in the third curve, then follows the instantaneous speed, setpoint.

The fourth curve of FIG. 7 represents the evolution of the dynamic Cd and static Cs torque setpoints in “Speed Creeping” mode. These torque setpoints evolve as a function of the variations in speed setpoint up to the instant t2 where the “Speed Creeping” mode is exited.

The formulation of the dynamic component “Cd_RV” of the setpoint in “RV” mode offers several advantages. It makes it possible for example to make the vehicle advance independently of its load and/or of the slope of the road. Furthermore, the motor vehicle can maintain a speed lying between the zero speed and the second threshold speed threshold_VV_in which can be of the order of 6 to 10 km/h according to the type of motor vehicle. In view of this, the “Speed Creeping” mode is especially well suited to the case where the driver of the motor vehicle is following a line of vehicles.

1-7. (canceled)

8. A method for controlling an automated transmission of a power train for a motor vehicle, comprising:
formulating a setpoint signal of a variable to be applied to wheels of the motor vehicle, the setpoint including a dynamic component and a static component formulated by taking account of input data representative of characteristics of the motor vehicle, of a desire of a driver, and of an environment of the motor vehicle; and
selecting, as a function of the input data, a mode from among at least two different operating modes, capable of delivering the setpoint signal, one of the two operating modes corresponding to a speed creeping mode configured to deliver the setpoint signal when the motor vehicle advances at a speed less than a predetermined threshold and when the brake pedal of the motor vehicle is inactivated.

9. The method as claimed in claim 8, wherein the speed creeping mode and/or a value of the setpoint delivered when the speed creeping mode is selected are determined as a function of a signal representative of a measured speed and/or of a signal representative of a target speed that the motor vehicle must reach.

10. The method as claimed in claim 9, wherein the speed creeping mode and/or a value of the setpoint delivered when the speed creeping mode is selected are determined as a function of a signal representative of the dynamic component of the setpoint undergoing application.

11. The method as claimed in claim 10, wherein the speed creeping mode and/or a value of the setpoint delivered when the speed creeping mode is selected are determined as a function of a signal representative of resistive torques applied to a wheel and that the motor vehicle must overcome so as to be able to move off.

12. A device for controlling an automated transmission of a power train for a motor vehicle, configured to deliver setpoint signals of a variable to be applied to wheels of the motor vehicle, the setpoint including a dynamic component and a static component, formulated by taking account of input data, delivered by an input block and including a list of parameters defining characteristics of the motor vehicle, a desire of a driver, and an environment of the motor vehicle, the device comprising:
a control block including at least two modules according to two distinct and predetermined operating modes, one of the modules corresponding to a speed creeping mode selected when the motor vehicle advances at a speed less than a predetermined threshold and when the brake pedal of the motor vehicle is inactivated; and
a selection module receiving signals originating from the input block and configured to deliver a selection signal for one of the modules as a function of the input data.

13. The device as claimed in claim 12, wherein the module corresponding to speed creeping mode comprises:
a calculation block configured to formulate a speed setpoint based on a measured speed of the motor vehicle, a target speed setpoint that the motor vehicle must reach, and an initialization signal,
correction means to perform a proportional and/or integral and/or derivative correction on the speed setpoint formulated by the first block and to deliver a corrected torque setpoint,
first means for initializing and adapting the speed setpoint to be corrected by the correction means performing an integral correction, as a function of the initialization signal and of a value of a dynamic torque setpoint undergoing application,
a filter configured to saturate and filter a raw dynamic torque setpoint in the speed creeping mode formulated based on the torque setpoints corrected by the correction means,
means for performing operations on variables delivered by the blocks included in the module corresponding to the speed creeping mode, and
means for delivering the static torque setpoint in the speed creeping mode based on the value of the dynamic torque setpoint in the speed creeping mode, a minimum torque quantity to be applied to a wheel, and a signal representative of resistive torques applied to the wheel and that the motor vehicle must overcome so as to be able to move off.

14. The device as claimed in claim 13, wherein the calculation block comprises:
second initialization means to initialize an intermediate variable, with a value of measured speed of the motor vehicle or a value of the speed setpoint formulated by the calculation block at a previous time,
saturation means to reduce a deviation between a target speed desired by the driver and the intermediate variable, and
means for performing operations on the variables delivered by the calculation block.
